(19) United States
(12) Patent Application Publication
(10) Pub. No.: US 2010/0192401 A1
(43) Pub. Date: Aug. 5, 2010

(54) Process and plant for treatment of wet material

(76) Inventors: Klaus Stanke, Baienfurt (DE); Jürgen Geyer, Bad Waldsee (DE); Armin Vonplon, Oberlunkhof (CH)

Correspondence Address: ALIX YALE & RISTAS LLP, 750 MAIN STREET, SUITE 1400, HARTFORD, CT, 06103, US

(21) Appl. No.: 12/308,618

(22) PCT Filed: Jun. 15, 2007
(86) PCT No.: PCT/AT2007/000293

§ 371 Date: Apr. 6, 2010

(30) Foreign Application Priority Data
Jun. 21, 2006 (AT) A 1043-2006

(51) Int. Cl. F26B 7/00; F26B 19/00

(52) U.S. Cl. 34/424; 34/62; 34/86

(57) ABSTRACT

The invention relates to a process for processing wet material, in particular sewage sludge, having a plurality of drying stages. At least one high-temperature drying stage 2 and at least one low-temperature drying stage 10 are provided, wherein the waste heat of the at least one high-temperature drying stage 2 is used for heating the at least one low-temperature drying stage 10. Great savings in energy and economic efficiency can thereby be achieved. In addition, the invention relates to a plant for carrying out the process.

The invention relates to a process for treatment of wet material, particularly sewage sludge, with several drying stages, and to a plant for carrying out the process.

In order to reduce the energy consumption, particularly in convective drying processes, the enthalpy of the waste gas is frequently utilised by directly backfeeding a partial flow, or the heat is transferred indirectly via recuperators, regenerators, or a secondary loop with heat exchangers. Due to the inevitable differences in temperature during heat transfer, processes of this kind are only of interest in the higher range of (waste gas) temperatures. In the low temperature range, efficiency can be increased substantially by input of energy. This makes use of so-called exhaust vapour compression, where the water that is vaporised during drying is compressed by applying mechanical energy and then used as high-tension steam for additional heating of the drying process. As a result, the latent heat can also be utilised. More recently, heat pump systems have been developed that raise exhaust heat to a usable temperature level with the aid of a suitable organic medium and mechanical energy, along the lines of the Rankine steam cycle in power generating plants. The material flows in these so-called ORC systems are entirely separate from the main process.

Furthermore, a sewage sludge drying process is known consisting of two dryers arranged in series, where the first dryer dissipates its waste heat to the second dryer and the partially dried product is fully dried in the second stage. The two dryers cannot be operated independently of one another here because the product network is necessary for the process to function: the first stage, a thin-film evaporator, can only dry partially, and the second stage, a belt dryer, requires a pre-dried, structured product.

The problem thus addressed by the present invention is to create a process and a plant for economic, energy-optimized drying of wet material, particularly of sewage sludge, by linking the energy flow, or the energy and material flows, of an energy-generating drying process to a consuming process.

The invention is thus characterised by at least one high-temperature drying process and at least one low-temperature drying process being provided, where the waste heat from the at least one high-temperature drying process is used to heat the at least one low-temperature drying process. A combination of high-temperature and low-temperature drying processes can be used to advantage on the one hand in plants with drying equipment for different products, but also in plants with drying stages arranged in series.

A favourable further development of the invention is characterised by the high-temperature drying process being designed as a full drying process, where a full drying process means drying to a dry content of more than approximately 85%, i.e. the product needs no further drying. In partial drying, a further drying stage is necessary.

An advantageous embodiment of the invention is characterised by the low-temperature drying process being designed as a full drying process.

An advantageous further development of the invention is characterised by the sludge in the high-temperature drying process being made into granulate and the hot granulate being fed to the low-temperature drying process.

The sludge can also be pre-dried in the low-temperature drying process and made into granulate, and the hot granulate can then be fed to the high-temperature drying process.

It is an advantage if only the waste heat from the at least one high-temperature drying process is used to heat the at least one low-temperature drying process. It has proved particularly favourable if the final section of the low-temperature drying process is designed as a cooling stage.

In a favourable embodiment of the invention, the high-temperature drying process is designed as a fluidised bed drying process. Here, the heat can be transferred particularly well to the wet material, particularly sewage sludge. In addition, the status or temperature of the waste heat is high enough to be used in a further stage.

An advantageous further development of the invention is characterised by the low-temperature drying process being designed as a belt drying process. This form of drying is a particularly gentle process.

The invention also refers to a plant for the treatment of wet material, particularly sewage sludge, with several dryers.

It is characterised by at least one high-temperature dryer and at least one low-temperature dryer being provided, where the waste heat from the at least one high-temperature dryer is used to heat the at least one low-temperature dryer. A combination of high-temperature and low-temperature dryers can be used to advantage on the one hand in plants with drying equipment for different products, but also where drying stages are arranged in series.

A favourable further development of the plant according to the invention is characterised by the high-temperature dryer being designed as a full dryer, where a full dryer achieves drying to a dryness of approximately 85%, i.e. the product does not require further drying. In partial drying a further drying stage is necessary.

An advantageous embodiment of the invention is characterised by the low-temperature dryer being designed as a full dryer.

It has proved to be an advantage if the outlet pipe for granulate from the high-temperature dryer is connected to the low-temperature dryer.

A favourable variant of the invention is characterised by the outlet pipe for granulate from the low-temperature dryer being connected to the high-temperature dryer.

In a particularly favourable embodiment of the plant according to the invention the exhaust air pipe from the high-temperature dryer is connected to the circulating air pipe of the low-temperature dryer, if necessary via a heat exchanger, for example a condenser.

An advantageous further development of the invention is characterised by the final section of the low-temperature dryer being designed as a cooling unit.

It has proved to be particularly favourable if the high-temperature dryer is designed as a fluidised bed dryer. Here, the heat can be transferred particularly well to the wet material, particularly sewage sludge. In addition, the status or temperature of the waste heat is high enough for it to be used in a further stage.

It is an advantage if the low-temperature dryer is designed as a belt dryer. Particularly gentle drying can be achieved with a dryer of this kind.

By combining two different drying processes and adapting the operating parameters, the waste heat from the high-temperature process covers the energy requirement of the low-temperature process. Here, a process using high-temperature heat is referred to as a high-temperature process. Similarly, a low-temperature process is operated with low-temperature heat. A high-temperature and a low-temperature dryer are thus dryers using high-temperature and low-temperature heat, respectively. The waste heat is contained in the exhaust steam or condensate from the scrubber, in the hot granulate, and in the flue gas from the thermal oil plant. Although the high-temperature process does not run at the optimum operating point as a result, the fact that the two are connected allows more than 80% more wet material to be dried without additional thermal energy being required. As a result, the specific energy required to evaporate one metric tonne of water drops from 800 and 860 kWh, respectively, at optimum individual operation of a fluidised bed dryer or belt dryer, to 470 kWh in the combined plant.

Availability of the system is just as high as in the individual process in spite of linking because industrially proven processes are used that can also be operated independently of one another by making small changes to parameters, thus approximately half of the drying performance is maintained if there is a fault in a part of the process, then of course without the advantage of the energy network.

The system is flexible, the material network is possible, but not absolutely essential in order to achieve a reduction in energy consumption. By linking the materials, however, it is possible to achieve much higher energy savings.

The process pays off particularly well economically if a second line is needed in any case in order to achieve higher capacity. A cooler for the total granulate quantity can be integrated into the low-temperature process; alternatively, partial drying and backfeeding of the granulate from low-temperature drying to high-temperature drying are also possible, however a separate cooler is then needed.

The invention is now described in examples based on the drawings, where

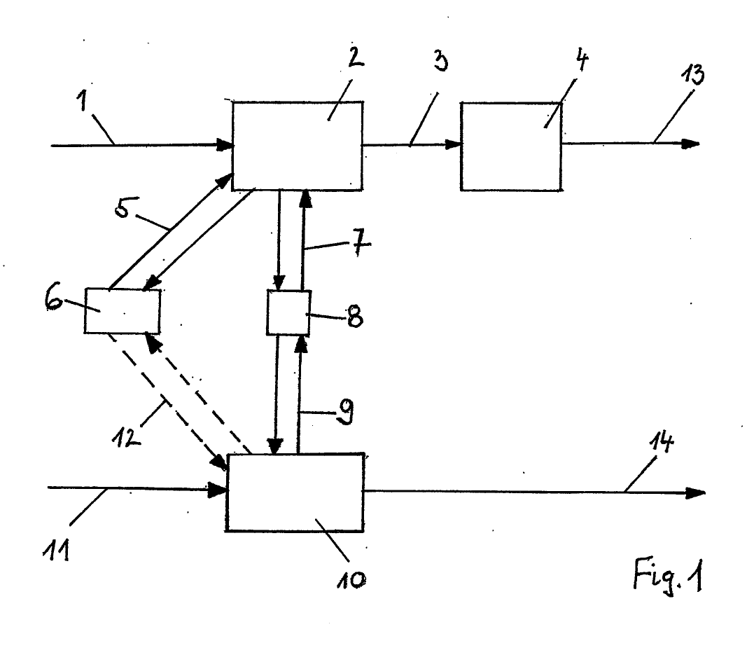

FIG. 1 shows an energy network for the two drying processes,

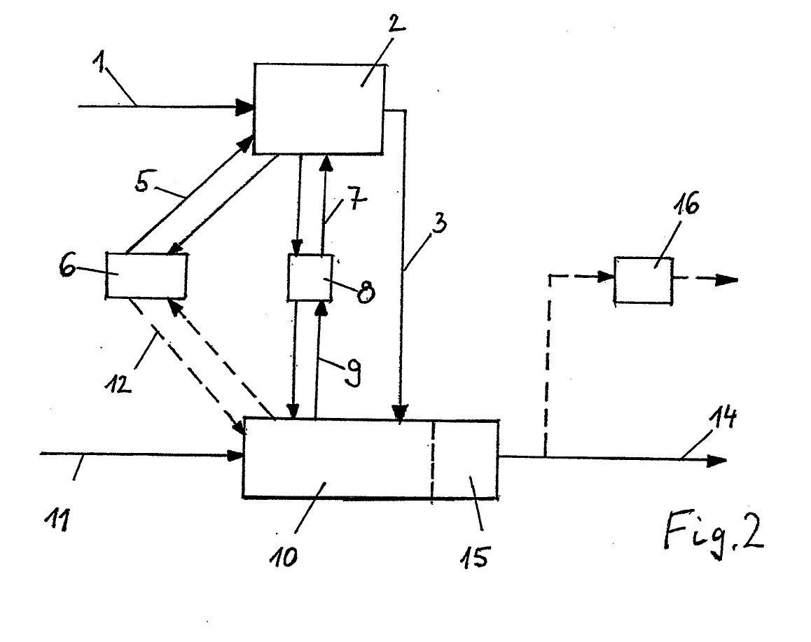

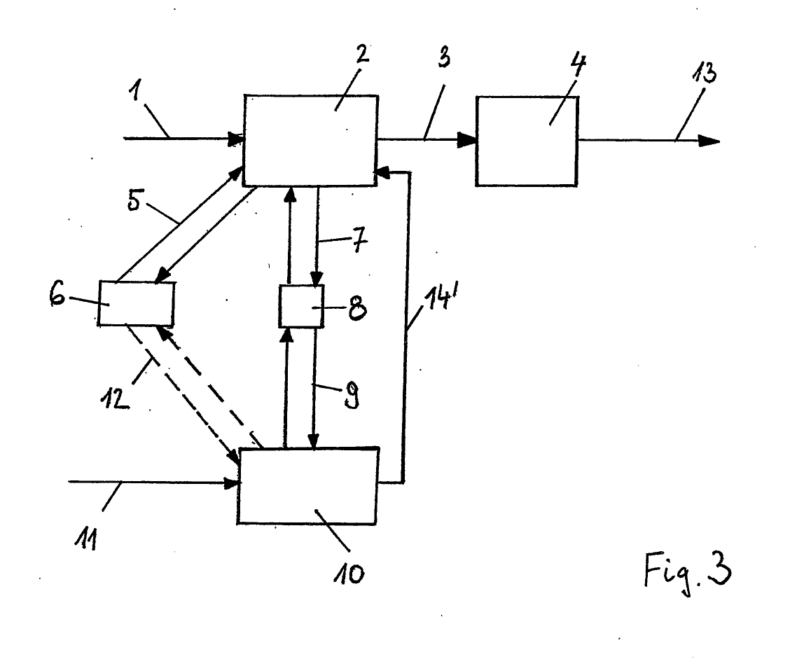

FIG. 2 a material and energy network, and FIG. 3 a material and energy network with partial drying.

FIG. 1 shows a variant of the invention with energy network. Wet material 1 is fed to the high-temperature dryer 2 and leaves it in a hot and dried state as granulate 3, to be reduced to storage temperature in the cooler 4. The heat is applied by means of a thermal oil circulating system 5, where the thermal oil is heated in a thermal oil plant 6. The water evaporated in the high-temperature dryer is contained in the circulating air and is fed to a scrubber 8 in a circulating air loop 7 and condensed there. The heat is applied to the low-temperature dryer 10 in a secondary loop 9. The low-temperature dryer 10 dries and cools more wet material 11. If the high-temperature dryer 2 fails and the waste heat thus cannot be utilised, a second thermal oil circulating system 12 can be used to supply the necessary energy to the low-temperature dryer 10. This provides high operating reliability. The granulate 13 from the high-temperature dryer 2 and the granulate 14 from the low-temperature dryer 10 are then stored and put to further use.

FIG. 2 shows the energy and material network for a plant according to the invention:

Unlike the process shown in FIG. 1, the hot granulate 3 from the high-temperature dryer 2 is fed to the low-temperature dryer 10 in addition to the wet material 11 so that it can release its heat and be cooled with the other material in the cooling zone 15 at the end of the low-temperature dryer. For reasons of overall economy it may be cheaper to do without an integrated cooling zone 15 and install a separate cooler 16 (shown with a broken line). Since, however, the hot granulate 3 from the high-temperature dryer 2 releases its heat largely to the other wet material 11 from the low-temperature dryer 10, cooling capacity, and thus heat loss, is considerably lower.

FIG. 3 shows a variant of the process with material and energy network using partial drying. The process differs from the process according to FIG. 1 in that the low-temperature dryer 10 only performs partial drying and the partially dried granulate 14′ is fed to the high-temperature dryer 2, where it undergoes further drying, is cooled in a cooler 4 together with the other granulate 3, and is then stored as granulate 13 and put to further use.

The thermal oil secondary loop 12 is not shown in all illustrations, nor is there an illustration of the trivial heat recovery stage from the flue gas of the thermal oil plant, where the exhaust heat is normally also used to heat the drying air for the low-temperature dryer 10.

Detailed functioning is described using the example of a fluidised bed dryer as high-temperature process and a belt dryer as low-temperature process, although other high-temperature or low-temperature processes can also be used.

Fluidised bed describes the status of a fluidised, packed bed with gas flowing through it, in which the individual particles—typically having a size between 20 and 5000 microns—are set in motion by the forces of the gas in such a way that they act like a fluid. Heat and material transport properties are improved considerably in this state. The energy required for drying can be supplied by means of the fluidising gas and/or to the heat exchanger surfaces that dip into the fluidised layer. In optimum sewage sludge drying the energy is only added via heat exchangers, which can be heated using thermal oil, for example. Heating is also possible, however, by incinerating the dried granulate produced. The fluidised bed process consists of a dryer 2, a gas circulating system 7 with condenser 8, a thermal oil plant 6, and a sludge treatment plant.

The inert gas is circulated in the loop 7, where it carries the moisture from the fluidised bed to the condenser 8, releases the excess moisture, and continues from there back to the dryer 2. Before it enters the condenser 8, the dust carried along with the gas is removed in a cyclone. The condenser 8 also operates as a scrubber and removes the remaining fine dust particles. In order to keep their concentration low, fresh water is added and discharged together with the condensate. The condensation heat is removed by means of a heat exchanger that is insensitive to contaminants and a secondary water loop 9. In a boiler fired by natural gas the thermal oil is heated to 250° C., for example, and fed to the heat exchanger in the fluidised bed. The flue gases typically leave the plant at a temperature of 180° C., and can be used further in the belt dryer 10. The sludge is pumped from a receiving silo to the dryer 2 and structured there into particle size using a built-in breaking-up device before being mixed into the fluidised bed. The fluidised bed consists of particles that have already been dried, and the fresh particles also dry and harden very quickly due to the efficient exchange. The particles are hot when they leave the fluidised bed dryer 2 and are cooled in the belt dryer 10, which uses the residual heat, according to the variant shown in FIG. 2. The dust removed in the cyclone is granulated with fresh sludge in a mixer and fed to the fluidised bed to be further dried.

The belt drying process comprises a dryer 10/cooler 15, gas circulating system, and sludge treatment equipment.

A gas-permeable belt, normally carrying a 5-20 cm high layer of structured, wet granulate, moves slowly inside the dryer 10/cooler 15. The hot gas flows from above through the layer and the belt, releases heat and absorbs moisture, in which process the particles dry. In order to achieve full utilisation and drying, the gas is fed through individual sections of the belt arranged one after the other. Ambient air is sucked in and cools the hot, dry granulate as it flows through it in the rear section of the belt, and is heated up in the process. It is heated further in the heat exchanger for the secondary water loop 9 and by mixing with the waste gas from the thermal oil plant 6, and flows through the front belt section. Then a partial flow of cooled, highly saturated drying air is discharged from the first belt section and conditioned in further treatment stages (cooling and saturating in a scrubber, dilution and cooling with fresh air) in such a way that it can be fed to a bio filter for deodorisation.

In a variation that is not shown, however, a gas circulating arrangement with condensation, as in the high-temperature process, is also possible.

The fresh sludge 11 is formed into granulate in a mixer using suitable mixing proportions of the hot, dry granulate from the fluidised bed 2 and cooled product from the belt discharge, and then distributed over the belt in a packed bed of even height. No dust is produced because of through-flow from top to bottom and because of the belt, which acts as a filter.

The following adjustments are required in order to combine both processes:

The condenser 8 from fluidised bed drying 2 is operated at 95° C., for example, instead of at 50-60° C. otherwise normally used, in order to provide a reasonable temperature level for transfer of energy to the belt dryer 10.

Since the steam condensate has a relatively high level of contamination, a clean, secondary water loop 9 is used to heat the gas for the belt dryer loop for reasons of operating safety and costs.

The temperature in the fluidised bed dryer 2 must also be raised, from 85° C. to 110° C. for example, so that the circulating gas with a very high moisture content does not condense here.

Both have a detrimental effect on efficiency and performance of fluidised bed drying. By using the waste heat from the condenser, the exhaust gases from the thermal oil heater, and the sensible heat from the overheated fluidised bed granulate, however, 70-80% more sludge can be dried without additional heat energy. In spite of the electricity required for gas circulation in the belt dryer 10 and the additional investment costs, this combined process is 10% more cost-effective.

The invention is not limited to the examples shown. It would also be possible, for example, to generate the heat applied by incinerating the dried granulate in a separate incinerating plant. In addition, all types of dryer can be used as well as fluidised bed and belt dryers provided that they use either high-temperature heat or low-temperature heat.

1. Process for treatment of wet material, particularly sewage sludge, with several drying stages, characterised by at least one high-temperature drying process and at least one low-temperature drying process being provided, where the waste heat from the at least one high-temperature drying process is used to heat the at least one low-temperature drying process.

2. Process according to claim 1, characterised by the high-temperature drying process being designed as a full drying process.

3. Process according to one of claim 1 or 2, characterised by the low-temperature drying process being designed as a full drying process.

4. Process according to one of claims 1 to 3, characterised by the sludge in the high-temperature drying process being made into granulate and the hot granulate being fed to the low-temperature drying process.

5. Process according to one of claims 1 to 3, characterised by the sludge in the low-temperature drying process being pre-dried and made into granulate, and the hot granulate being fed to the high-temperature drying process.

6. Process according to one of claims 1 to 5, characterised by only the waste heat from the at least one high-temperature drying process being used to heat the at least one low-temperature drying process.

7. Process according to one of claims 1 to 6, characterised by the final section of the low-temperature drying process being designed as a cooling stage.

8. Process according to one of claims 1 to 7, characterised by the high-temperature drying process being designed as a fluidised bed drying process.

9. Process according to one of claims 1 to 8, characterised by the low-temperature drying process being designed as a belt drying process.

10. Process according to one of claims 1 to 9, characterised by the heat from incineration of the granulate produced being generated in a separate incinerating plant

11. Plant for the treatment of wet material, particularly sewage sludge, with several dryers, characterised by at least one high-temperature dryer (2) and at least one low-temperature dryer (10) being provided, where the waste heat from the at least one high-temperature dryer (2) is used to heat the at least one low-temperature dryer (10).

12. Process according to claim 11, characterised by the high-temperature dryer (2) being designed as a full dryer.

13. Process according to claim 11 or 12, characterised by the low-temperature dryer (10) being designed as a full dryer.

14. Plant according to one of claims 11 to 13, characterised by the outlet pipe (3) for hot granulate from the high-temperature dryer (2) being connected to the low-temperature dryer (10).

15. Process according to one of claims 11 to 13, characterised by the outlet pipe (14′) for hot granulate from the low-temperature dryer (10) being connected to the high-temperature dryer (2).

16. Process according to one of claims 11 to 15, characterised by the exhaust air pipe (7) from the high-temperature dryer (2) being connected via a heat exchanger (8), for example a condenser, to the circulating air pipe of the low-temperature dryer (10).

17. Plant according to one of claims 11 to 16, characterised by the final section of the low-temperature dryer (10) being designed as a cooling unit (15).

18. Plant according to one of claims 11 to 17, characterised by the high-temperature dryer (2) being designed as a fluidised bed dryer.

19. Plant according to one of claims 11 to 18, characterised by the low-temperature dryer (10) being designed as a belt dryer.

20. Plant according to one of claims 11 to 19, characterised by a separate incinerating plant for the granulate produced being provided to generate heat.
